(19) United States
(12) Patent Application Publication
(10) Pub. No.: US 2026/0324553 A1
(43) Pub. Date: Oct. 22, 2026

(54) SPINDLE CLEANING ASSEMBLY FOR COTTON HARVESTING WORK VEHICLE

(71) Applicant: Deere & Company, Moline, IL (US)

(72) Inventors: Adam R. Eaker, Ankeny, IA (US); Brandon C. Carlson, Ankeny, IA (US); Bing Hui Dong, Ankeny, IA (US)

(21) Appl. No.: 19/356,923

(22) Filed: Oct. 13, 2025

Related U.S. Application Data
(60) Provisional application No. 63/790,520, filed on Apr. 17, 2025.

(51) Int. Cl. A01D 46/14

(52) U.S. Cl. CPC A01D 46/14

(57) ABSTRACT

A spindle cleaning assembly for a harvesting unit of a cotton harvesting work vehicle is disclosed. The spindle cleaning assembly includes a fluid nozzle, and a fluid distributor configured to receive fluid from the fluid nozzle. The fluid distributor defining an interior distribution chamber disposed about a longitudinal axis. The interior distribution chamber is defined at least in part by an impingement plate at which the fluid nozzle is configured to spray a fluid. The impingement plate having raised flow dividers angularly spaced about the longitudinal axis to distribute the fluid radially outward to an array of outlet openings. The spindle cleaning assembly further includes distributor tubes attached to the fluid distributor, one at each of the outlet openings, and a column of applicator pads carried by the housing panel to be spaced apart along the housing panel and receive fluid from the fluid distributor through the distributor tubes.

### CROSS-REFERENCE TO RELATED APPLICATION(S)

This application claims the benefit of U.S. provisional application Ser. No. 63/790,520, filed Apr. 17, 2025, which is incorporated herein in its entirety.

### STATEMENT OF FEDERALLY SPONSORED RESEARCH OR DEVELOPMENT

Not applicable.

### FIELD OF THE DISCLOSURE

This disclosure generally relates to a spindle cleaning assembly for lubricating and cleaning spindles in a cotton harvesting work vehicle.

### BACKGROUND OF THE DISCLOSURE

Cotton harvesting work vehicles include a cotton harvesting system and a moisture system. The cotton harvesting system includes spindles and doffers. The spindles rotate and separate the cotton from the plant, and the doffers strip the cotton off the spindles. Debris from the cotton plants (e.g., cotton, cotton sap, and/or other plant debris) may remain on the spindles after the doffer removes the cotton. As such, the cotton related debris may stick to the spindles and eventually build up on the spindles. To mitigate the build-up of debris, the spindles pass through a spindle cleaning assembly (e.g., a moisture column) of the moisture system to lubricate and clean the spindles to remove and help prevent the debris from sticking to the spindles.

### SUMMARY OF THE DISCLOSURE

In one implementation, a spindle cleaning assembly for a harvesting unit of a cotton harvesting work vehicle. The spindle cleaning assembly may include a fluid nozzle and a fluid distributor carried by a housing panel of the harvesting unit and configured to receive fluid from the fluid nozzle. The fluid distributor may define an interior distribution chamber disposed about a longitudinal axis. The interior distribution chamber may be defined at least in part by an impingement plate at which the fluid nozzle may be configured to spray a fluid. The impingement plate may have raised flow dividers angularly spaced about the longitudinal axis to distribute the fluid radially outward to an array of outlet openings. The spindle cleaning assembly may further include distributor tubes attached to the fluid distributor, one at each of the outlet openings. The spindle cleaning assembly may further include a column of applicator pads carried by the housing panel and spaced apart along a longitudinal axis and receive fluid from the fluid distributor through the distributor tubes.

In an example of the spindle cleaning assembly, the impingement plate may be higher at the center than the outer edge. In an example of the spindle cleaning assembly, the impingement plate may include a tapered conical surface, and the raised flow dividers may extend along the longitudinal axis from the tapered conical surface toward an apex of the tapered conical surface.

In an example of the spindle cleaning assembly, the fluid distributor may further include upper flow dividers angularly spaced about the longitudinal axis. In an example of the spindle cleaning assembly, the upper flow dividers may be tapered along the longitudinal axis. In an example of the spindle cleaning assembly, each upper flow divider may align with a raised flow divider.

In an example of the spindle cleaning assembly, each outlet opening may be positioned between two raised flow dividers. In an example of the spindle cleaning assembly, the outlet openings may be distributed evenly around the longitudinal axis.

In an example of the spindle cleaning assembly, the fluid nozzle may be configured to distribute fluid into the interior distribution chamber in a hollow cone, and the fluid nozzle may be positioned for the hollow cone to point at the impingement plate along the longitudinal axis. In an example of the spindle cleaning assembly, the impingement plate may include a tapered conical surface, the fluid nozzle may be configured to distribute fluid into the interior distribution chamber in a hollow cone, and the fluid from the fluid nozzle may contact the tapered conical surface around an apex of the tapered conical surface.

In one implementation, a harvesting unit of a cotton harvesting work vehicle is disclosed. The harvesting unit may include a spindle drum including an array of spindle holding bars configured to rotate about a rotation axis of the spindle drum, wherein each spindle holding bar comprises a column of spindles. The harvesting unit may further include a spindle cleaning assembly for cleaning and lubricating each spindle of the column of spindles, wherein during rotation of the spindle drum each spindle holding bar passes through the spindle cleaning assembly. The spindle cleaning assembly may include a fluid nozzle, and a fluid distributor carried by a housing panel of the harvesting unit and configured to receive fluid from the fluid nozzle. The fluid distributor may define an interior distribution chamber disposed about a longitudinal axis and the interior distribution chamber may be defined at least in part by an impingement plate at which the fluid nozzle is configured to spray a fluid. The impingement plate may have raised flow dividers angularly spaced about the longitudinal axis to distribute the fluid radially outward to an array of outlet openings. The spindle cleaning assembly may further include distributor tubes attached to the fluid distributor, one at each of the outlet openings. The spindle cleaning assembly may further include a column of applicator pads carried by the housing panel to be spaced apart along a longitudinal axis and receive fluid from the fluid distributor through the distributor tubes, wherein column of spindles of a spindle holding bar may contact the column of applicator pads as the spindle holding bar passes through the spindle cleaning assembly.

In an example of the harvesting unit, the impingement plate may be higher at the center than the outer edge. In an example of the harvesting unit, the impingement plate may include a tapered conical surface, and the raised flow dividers extend along the longitudinal axis from the tapered conical surface toward an apex of the tapered conical surface.

In an example of the harvesting unit, the fluid distributor may further include upper flow dividers angularly spaced about the longitudinal axis. In an example of the harvesting unit, the upper flow dividers may be tapered along the longitudinal axis. In an example of the harvesting unit, each upper flow divider may be aligned with a raised flow divider.

In an example of the harvesting unit, each outlet opening may be positioned between two raised flow dividers. In an example of the harvesting unit, the outlet openings may be distributed evenly around the longitudinal axis.

In an example of the harvesting unit, the fluid nozzle may be configured to distribute fluid into the interior distribution chamber in a hollow cone, and the fluid nozzle may be positioned for the hollow cone point at the impingement plate along the longitudinal axis. In an example of the harvesting unit, the impingement plate may include a tapered conical surface, the fluid nozzle may be configured to distribute fluid into the interior distribution chamber in a hollow cone, and the fluid from the fluid nozzle may contact the tapered conical surface around an apex of the tapered conical surface.

### BRIEF DESCRIPTION OF THE DRAWINGS

FIG. 1 is a perspective view of an example cotton harvesting work vehicle in which the present disclosure may be incorporated;

FIG. 2 is a schematic diagram a harvesting unit of a cotton harvesting work vehicle being used to harvest cotton;

FIG. 3 is a perspective view of a spindle cleaning assembly for a cotton harvesting work vehicle;

FIG. 4 is an enlarged partial detailed cross-section view taken along cross-section line 4-4 of FIG. 3;

FIG. 5 is a partial perspective view of a fluid inlet assembly proximate a fluid distributor of the spindle cleaning assembly;

FIG. 6 is a partial detailed view showing area 6 of FIG. 4;

FIG. 7 is a cross-section view thereof taken along cross-section line 7-7 of FIG. 3; and

FIG. 8 is a cross-section view thereof taken along cross-section line 8-8 of FIG. 3.

Throughout the drawings, identical reference numbers designate the same element. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Example embodiments of the present disclosure are shown in the accompanying figures of the drawings described briefly above. Various modifications to the example embodiments may be contemplated by one of skill in the art without departing from the scope of the present invention, as set forth in the appended claims.

### Overview

Cotton harvesting work vehicles include a cotton harvesting system and a moisture system. The cotton harvesting system includes spindles and doffers. The spindles rotate and separate the cotton from the plant and the doffers strip the cotton off the spindles. The cotton may then be guided to a suction duct to move the cotton to a storage basket on the cotton harvesting work vehicle. Debris from the cotton plants (e.g., cotton, cotton sap, and/or other plant debris) may remain on the spindles after the doffer removes the cotton. As such, the debris may stick to the spindles and eventually build up on the spindles. To reduce or prevent the build-up of debris, the spindles pass through a spindle cleaning assembly (e.g., a moisture column) to lubricate and clean the spindles and help prevent the debris from sticking to the spindles.

The spindle cleaning assembly in a cotton harvesting unit applies a cleaning and lubricating fluid to the spindle surfaces during operation. The cleaning and fluid application is essential for enhancing harvest efficiency and preventing the accumulation of cotton debris. The spindle cleaning assembly features an array of applicator pads aligned such that spindles pass by and contact an applicator pad to facilitate this process. For example, as each spindle passes by the spindle cleaning assembly and the applicator pads contact the spindles and dispense a fluid through apertures onto the spindles. The applicator pads receive fluid through tubes coupled to a fluid distributor. Pressurized fluid is dispensed through a nozzle feeding into a distribution chamber within the fluid distributor. The fluid distributor directs the fluid to outputs coupled to the tubes to provide fluid to the applicator pads. At times, an operator may apply a flush application that increases the amount of fluid supplied to the fluid distributor for distribution to the applicator pads. Existing designs may struggle with equal distribution of the fluid during both the regular application and the flushing application, leading to inefficiencies in performance. For example, uneven solution distribution in the spindle cleaning assembly may lead to inefficient cleaning and lubrication of the spindle surfaces. Having the spindle cleaning assembly not maintain consistent application of the fluid to the spindles, particularly during flush mode, may result in excessive cotton build-up and reduced harvesting efficiency for the cotton harvesting work vehicle.

The present disclosure provides a spindle cleaning assembly with an improved fluid distributor. The fluid distributor may define an interior distribution chamber and disposed about a longitudinal axis. The interior distribution chamber may define at least in part by an impingement plate at which a fluid nozzle sprays fluid. The fluid distributor may receive the fluid nozzle and direct the nozzle at the impingement plate. The impingement plate may have raised flow dividers angularly spaced about the longitudinal axis to distribute the fluid radially outward to an array of outlet openings. The impingement plate may have a tapered surface with the outlet openings space around the tapered surface. The tapered surface may be a tapered conical surface. The fluid may be sprayed in a hollow cone out of a nozzle at the tapered surface. The sprayed fluid flows down the tapered surface between the raised flow dividers to reach the outlet openings. The raised flow dividers help to overcome surface tension of the fluid, which may act like a plug stopping the fluid from flowing smoothly to and out the outlet openings. The raised flow dividers also maintain an even distribution of the fluid reaching each outlet opening. The fluid may then exit the fluid distributor and flow to a column of applicator pads.

A pump may send pressurized fluid to the nozzle of the fluid inlet. The pressurized fluid may exit the nozzle in a hollow cone supplying fluid between the raised flow dividers positioned on the impingement plate. The pump may send fluid at a first pressure during normal operation. During a flush application/operation, the pump sends fluid at a second pressure greater than the first pressure. This may supply more fluid through the fluid distributor and to the applicator pads. The raised flow dividers may enhance the guidance of the fluid towards the intended outlet ports, ensuring a more uniform distribution of the fluid across all applicator pads in both the normal operation and the flush operation.

The raised flow dividers may extend along the impingement plate and up a tapered surface of the impingement plate. The raised flow dividers may extend along the longitudinal axis from the tapered surface toward the apex of the tapered surface. The raised flow dividers may extend at least three quarters up the longitudinal height of the tapered surface. An outlet opening may be positioned between each raised flow divider. The fluid may be sprayed in a hollow cone onto the tapered surface such that the radius of the base of the hollow cone is great enough for the fluid to spray onto the raised fluid dividers and tapered surface. Gravity may cause the fluid to flow down the tapered surface to the outlet openings. The sprayed fluid may be caught between the raised fluid dividers and the raised fluid dividers may guide the fluid to an outlet opening allowing an even distribution of fluid to each outlet opening. For example, if the cotton harvesting work vehicle is on sloped ground the raised fluid dividers may catch the sprayed fluid and prevent gravity from flowing more fluid to one outlet opening compared to another outlet opening. In either normal operation or a flush operation, the sprayed fluid may be caught between the raised fluid dividers and guided to the outlet openings.

The fluid distributor may also include upper flow dividers angularly spaced about the longitudinal axis. The upper flow dividers may run along the interior surface in the direction of the longitudinal axis and may extend toward the longitudinal axis. The upper flow dividers may be tapered towards the raised flow dividers. The upper flow dividers may break up turbulence within the interior distribution chamber allowing the fluid to flow smoothly to the impingement plate. For example, the upper flow dividers may break up any swirling within the interior distribution chamber. The fluid is sprayed under pressure out of a nozzle and as such, some of the fluid may splash off the impingement plate and onto the walls of the interior distribution chamber. The upper flow dividers may guide this splashed fluid down the walls of the walls of the interior distribution chamber to reach an outlet opening. The upper flow dividers may be aligned with the raised flow dividers and there may be the same number of upper flow dividers as raised flow dividers. As such, the upper flow dividers may guide the splashed fluid down the walls of the interior distribution chamber to between raised flow dividers. This process allows even the splashed fluid or any other fluid that builds up on the walls to be segregated and guided to the outlet openings providing an even distribution of the fluid to each outlet opening.

The flush operation may be initiated by the operator pressing a button. The pressing of the button may initiate a controller to increase the pressure at the pump providing more fluid to the fluid distributor. In an additional/alternative aspect, the flush operation may be automated by the controller to perform a flush operation for critical harvesting moments, reducing operator workload and enhancing overall harvesting performance. For example, the controller may initiate a flush operation after a period of time. For example, perform a flush operation after 10 minutes of normal operation. The controller may also determine that the cotton harvesting work vehicle has completed harvesting a row of cotton and then perform the flush operation. For example, the controller may detect that the cotton harvesting work vehicle is turning at an angle greater than a threshold and initiate the flush operation. The threshold angle may be an angle great enough to turn the cotton harvesting work vehicle to align with a new row of cotton for harvesting. The controller may also automatically initiate a flush operation when the cotton harvesting unit is initially engaged for harvesting. In any case, the controller may automate the flush operation and also receive input from a button so the controller may initiate a flush operation automatically or receive an input from an operator to initiate a flush operation.

The fluid distributor may be designed to allow tool-less removal of the nozzle for cleaning or replacement. The fluid inlet may include the nozzle extending out of a housing of the fluid inlet. The fluid inlet may include a hand tightening nut that presses and maintains the fluid inlet housing against the fluid distributor. The hand tightening nut may have an inner geometric feature that mates with an external geometric feature on the fluid inlet housing. For example, the geometric features may be a hexagon, star, etc. By mating these geometric features, the user may hold the hand tightening nut to easily rotate the fluid inlet housing with the user's hand. The nozzle may insert through a nut that is tightened against an end of the fluid inlet housing. The nut pressing and maintaining the nozzle in position against the end of the fluid inlet housing. The user may insert the fluid inlet into the receiving end of the fluid distributor. The receiving end of the fluid distributor may have a geometry that mates with the nut to prevent the nut from rotating. For example, the geometry may be a hexagon shape. The user may rotate the hand tightening nut which when mated with the external geometry on the fluid inlet housing causes the fluid inlet housing to rotate relative to the nut held in place by the fluid distributor. As such, the user may rotate by hand the fluid inlet housing to loosen or tighten the nut holding the nozzle in position allowing the user to remove to clean or replace the nozzle.

The improved fluid distributor enhances the efficiency and effectiveness of the spindle cleaning assembly in cotton harvesting units through the design modifications. By incorporating strategically placed raised flow dividers in the distribution chamber the invention ensures uniform solution distribution to all applicator pads, improving cleaning and lubrication. The flushing application is enabled by passing fluid through the nozzle at increased pressure and the raised flow dividers are designed to properly guide the addition fluid to the proper outlet openings to reach the applicator pads.

An example embodiment of a spindle cleaning assembly is provided according to the present disclosure. The following description should be understood as merely providing one or more non-limiting examples context in which embodiments of the present disclosure may be better understood.

### Example Spindle Cleaning Assembly

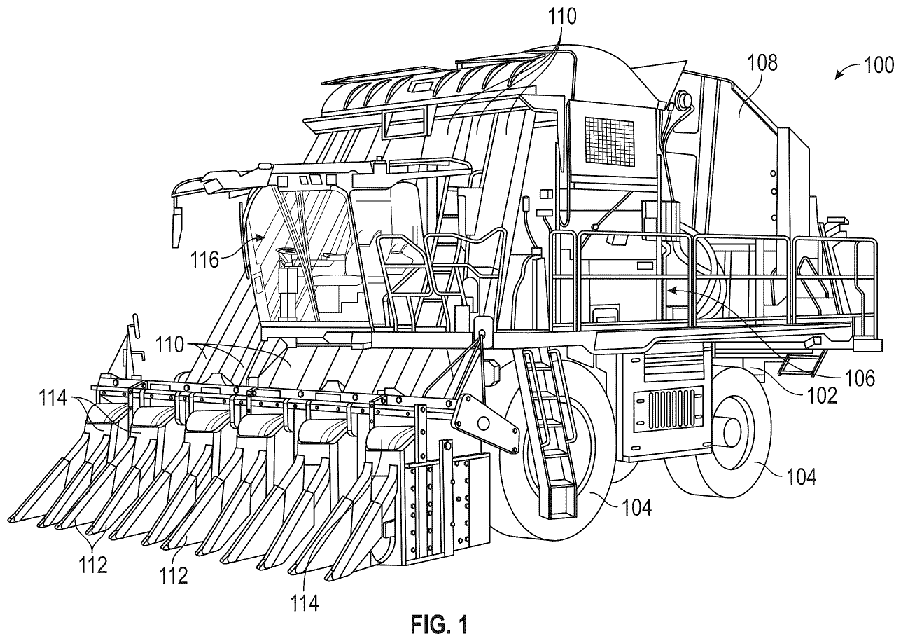

Referring to FIG. 1, a cotton harvesting work vehicle 100 is shown that can implement embodiments of the disclosure. In the illustrated example, the cotton harvesting work vehicle 100 is depicted as a cotton picker. The cotton harvesting work vehicle 100 includes a chassis 102 (i.e., frame) carried on front and rear wheels 104. Positioned in a middle region of the chassis 102 is an engine 106. The engine system provides power via an associated drivetrain to an output member (e.g., an output shaft, not shown) that, in turn, transmits power to axle(s) of the work vehicle 100 to provide propulsion thereto and additionally powers the other implements of the cotton harvesting work vehicle 100.

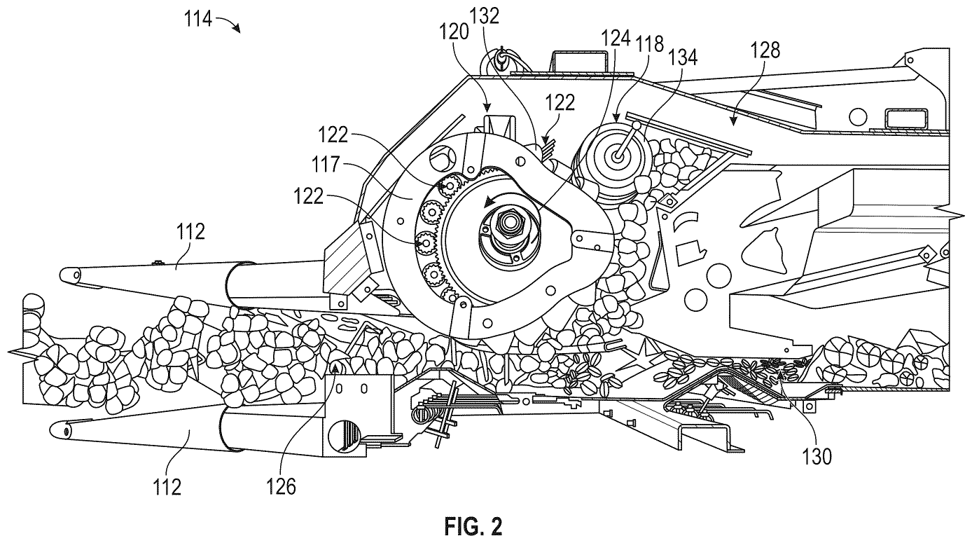

The cotton harvesting work vehicle 100 includes a basket 108, suction ducts 110, stalk lifters 112, and harvesting units 114. These implements may each be powered by the engine 106. Each harvesting unit 114 may have two stalk lifters 112 attached to an input 126 (FIG. 2) of the harvesting unit 114 and each harvesting unit 114 has a suction duct 110 connected to the output side of the harvesting unit 114. The suction ducts 110 extend from a harvesting unit 114 to the basket 108. As the cotton harvesting work vehicle 100 is operated, the stalk lifters 112 may lift and guide cotton stalks into the harvesting units 114. The harvesting units 114 strip the cotton off the cotton stalks. The cotton stalks with the cotton removed travel through the cotton harvesting units 114 to be placed back on the ground. The harvested cotton may be suctioned through the suction ducts 110 and into the basket 108. The operator may operate the cotton harvesting work vehicle 100 to harvest cotton until the basket 108 is full of cotton.

The cotton harvesting work vehicle 100 may include a controller to monitor parameters of the cotton harvesting work vehicle 100. For example, the cotton harvesting work vehicle 100 may include an operator cabin 116 including one or more display devices and any of various operator interfaces coupled to the controller. Apart from the display devices, the operator interface devices may include various video and audio devices for providing video and audio information, haptic devices that provide haptic feedback, levers, joysticks, steering wheels, pedals, buttons, and so on. Operator interface devices can also be a set of inputs displayed on the display devices, for example, links, icons, or other user actuatable mechanisms. Additionally, or alternatively, some portion of the operator interfaces may be integrated into the display devices, such that the operator interfaces may include physical inputs (e.g. buttons, switches, dials, etc.) on or near the display devices, a touchscreen module integrated into the display devices, or a cursor input device (e.g., a joystick, trackball, or mouse) for positioning a cursor utilized to interface with GUI elements generated on the display devices. The display devices can be any image-generating device configured for operation within the operator cabin, including one or more dedicated display consoles and various heads-up display projectors.

The display devices and operator interfaces are operatively coupled to the controller with various data connections between these components representative of wired and/or wireless data connections. The controller may have one or more controllers or other control architecture that can assume any form suitable for performing the functions described herein and is used in a non-limiting sense to generally refer to the processing architecture or system of the cotton harvesting work vehicle 100 or other computing device or group of devices. For example, the controller may encompass or may be corresponding to any practical number of processors, control computers, computer-readable memories, power supplies, storage devices, interface cards, and other standardized components, and may also include or cooperate with any number of firmware and software programs or computer-readable instructions designed to carry-out the various process tasks, calculations, and control/display functions described herein, all represented by a processor. Such computer-readable instructions may be stored within a non-volatile sector of a local onboard memory, which is accessible to the controller. While generically illustrated as a single block, the memory can encompass any number and type of storage media suitable for storing computer-readable code or instructions, as well as other data utilized to support the operation of the cotton harvesting work vehicle 100. The memory may be integrated into the controller architecture in various embodiments such as, for example, a system-in-package, a system-on-a-chip, or another type of microelectronic package or module.

The cotton harvesting work vehicle 100 may include a plurality of sensors coupled to the controller. The sensors may provide the controller with data regarding the different implements and/or engine of the cotton harvesting work vehicle 100. For example, the basket 108 may include a sensor to provide data indicative of the fullness of the basket 108. Another example is a sensor providing data indicative of how full a moisture tank is for the harvesting units 114. Another example is a sensor providing data indicative of a jam occurring within a harvesting unit 114. There are various other sensors that may be on the cotton harvesting work vehicle 100. The controller monitors the signals or data received from the sensors and adjusts operation of the cotton harvesting work vehicle 100 based on the data. The controller may also provide the operator with information regarding the data. For example, providing the operator with information regarding how full the basket 108 is currently as well as other parameters of the cotton harvesting work vehicle 100.

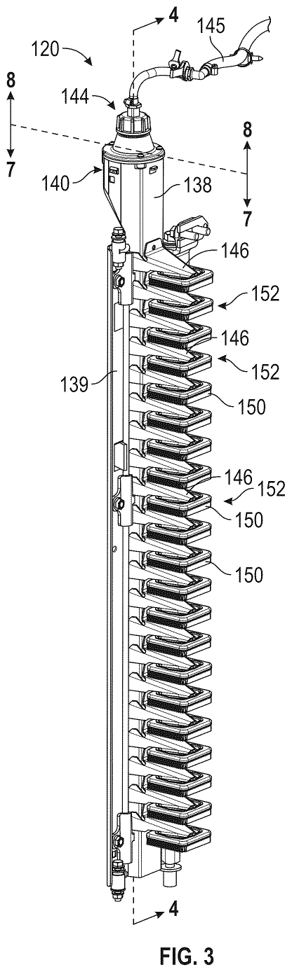

Referring to FIG. 2, each harvesting unit 114 may include a spindle drum 117, a doffer assembly 118, and a spindle cleaning assembly 120. The spindle drum 117 may include a plurality of spindle holding bars 132 and spindles 122 (FIG. 3) that rotate around the rotation axis 124. Each spindle holding bar 132 includes a plurality of spindles 122 attached along the spindle holding bar 132. Each spindle 122 attaches to the spindle holding bar 132 proximate a base of the spindle and extends to a distal end of the spindle 122. The spindle holding bar 132 may function as a spindle holding bar. Each harvesting unit 114 has an input 126, a cotton output 128, and a stalk output 130. The stalk lifters 112 may lift and guide cotton stalks into the input 126 of the harvesting unit 114. The cotton stalks may be guided to the spindle drum 117. The spindle holding bars 132 rotate around the rotation axis to move the spindles 122 into contact with the cotton stalks. Each spindle 122 rotates about itself to remove the cotton from the cotton stalk by twisting the cotton onto the spindle. Once the cotton is removed from the cotton stalk, the empty stalks are guided out the stalk output 130 and the stalks fall to or remain in the ground. The rotation of the spindle holding bar 132 moves the spindles 122 with cotton toward the doffer assembly 118. The doffer assembly 118 includes a plurality of doffers. In at least one aspect, each doffer may be a rubber disk. As the spindle holding bar 132 rotates past the doffer assembly 118, each spindle 122 may contact a doffer 134 and the doffer 134 may remove the harvested cotton from the spindle 122. For example, the doffers 134 may rotate faster than the spindle 122 and in an opposing direction to “unwind” the cotton from the spindle 122. The harvested cotton may then be guided out the cotton output 128 and into a suction duct 110 to be suctioned into the basket 108.

The spindle holding bar 132 and spindles 122 are then rotated around the rotation axis 124 toward the spindle cleaning assembly 120. The spindles 122 pass by and contact the spindle cleaning assembly 120, where the spindle cleaning assembly 120 cleans and lubricates each spindle 122 on the spindle holding bar 132. The cleaning and lubricating of the spindles 122 help to remove cotton debris and prevent buildup of cotton debris. After the spindle holding bar 132 and spindles 122 pass by the spindle cleaning assembly 120, the spindle holding bar 132 and spindles 122 continue to rotate around the rotation axis 124 on the spindle drum 117 to reach new cotton stalks that entered through the input 126. The spindles 122 harvest the cotton from these new stalks and the cycle of harvesting cotton and passing through the spindle cleaning assembly 120 continues as the spindle drum 117 rotates.

Referring to FIG. 3, the spindle cleaning assembly 120 includes a housing 138, a fluid distributor 140, distributor tubes 142, a fluid inlet 144, and a column of applicator pad assemblies 136. In at least one aspect, the spindle cleaning assembly 120 may be considered a moistener column. The housing 138 may include a housing panel 139. The housing panel 139 may be attached to a housing of the cotton harvesting unit 114 to position the spindle cleaning assembly 120 relative to the cotton harvesting unit 114. The column of applicator pad assemblies 136 may be attached and distributed along the housing 138. The distribution of the applicator pad assemblies 136 matches the distribution of spindles 122 along the spindle holding bar 132.

Each applicator pad assembly 136 may include an applicator pad holder 146 and an applicator pad 150. Each applicator pad holder 146 attaches to the housing 138 and extends away from the housing 138 to a distal end 152 of the applicator pad holder 146. The applicator pad 150 is attached to the distal end 152. An applicator pad coupler may couple the applicator pad 150 to the distal end 152. For example, an applicator pad coupler may attach to both the distal end 152 and the applicator pad 150 to position the applicator pad 150 proximate the distal end 152.

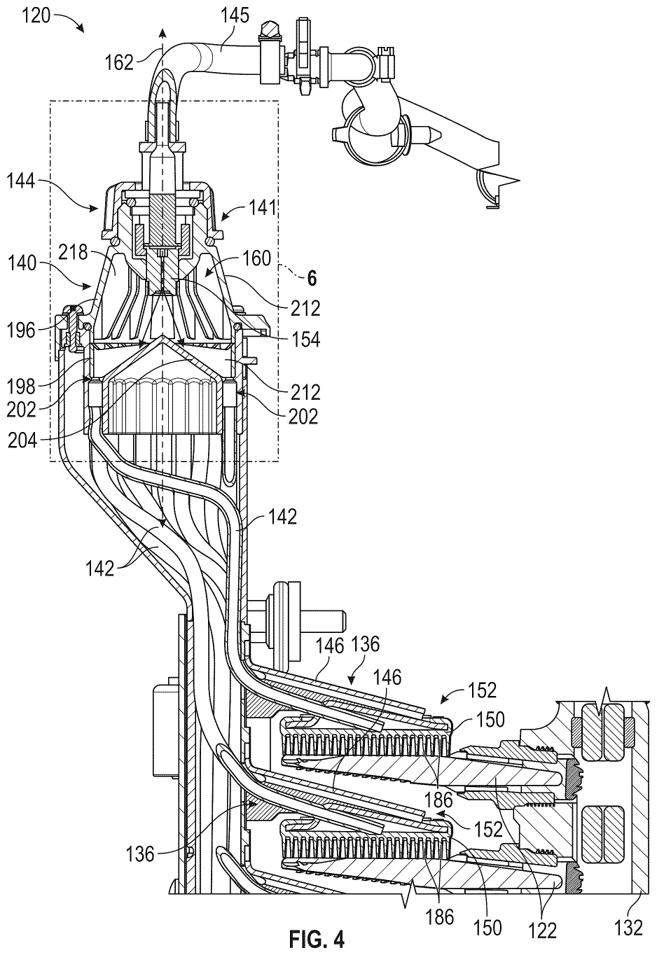

Referring to FIG. 4, pressurized fluid enters the fluid inlet 144 at the top of a fluid inlet housing 158. The fluid inlet 144 may be received within the fluid distributor 140. For example, the fluid inlet 144 may insert into the fluid distributor 140 and the fluid inlet housing 158 may attach to the fluid distributor 140 at a receiving end 141. The fluid distributor 140 defines an interior distribution chamber 160 about a longitudinal axis 162 of the fluid distributor 140. The fluid inlet 144 may include a nozzle 154 extending away from the fluid inlet housing 158. The fluid inlet 144 may be received by the fluid distributor such that the nozzle 154 sprays fluid into the interior distribution chamber 160. In at least one aspect, the nozzle 154 may spray a hollow cone of fluid. In at least one aspect, the fluid that passes through the nozzle 154 is no longer under pressure after passing through the nozzle 154.

The nozzle 154 may spray the fluid onto an impingement plate 156 within the fluid distributor 140. The fluid may flow down the impingement plate 156 to reach one of an array of fluid outputs of the fluid distributor 140, where each output is connected to a distributor tube 142. The distributor tubes 142 may extend from the fluid distributor 140 to an applicator pad assembly 136 to fluidically couple the fluid distributor 140 to an applicator pad 150. The distributor tubes 142 are housed within the housing 138 and exit the housing 138 to inside of an applicator pad holder 146. The distributor tube 142 extends down the applicator pad holder 146 to reach the applicator pad 150. The fluid exiting the fluid distributor 140 may travel through the distributor tubes 142 to reach an applicator pad 150. In at least one aspect, the fluid is gravity fed through the distributor tubes 142.

Each applicator pad 150 includes one or more contact features 186 projecting away from the applicator pad 150. The one or more contact features 186 may contact a spindle 122 as a spindle 122 moves past the applicator pad 150. The contact features 186 may be flexible and would not break due to contact with the spindle 122. The contact between the applicator pad 150 and the one or more contact features 186 may help to remove any buildup of debris from the cotton plants. The one or more contact features 186 may also help spread the fluid sprayed through the through holes in the applicator pad 150 onto the spindle 122 surface. Each of the one or more contact features 186 may be tapered. In at least one aspect, the one or more contact features 186 may be fins positioned across the applicator pad 150. The one or more contact features 186 may be spaced and positioned along the entire applicator pad 150.

The fluid for each spindle cleaning assembly 120 positioned within the harvesting units 114 may come from a fluid tank (not shown). The fluid inlet 144 may be coupled to the fluid tank by a tube 145. A pump (not shown) may pump fluid from the fluid tank down the tube 145 to reach each spindle cleaning assembly 120. The fluid may be pumped down the tube 145 at a pressure above a pressure threshold value. The pressure threshold value may be determined based on the number of spindle cleaning assemblies 120 being supplied fluid by the pump. The pressure threshold value may also be determined based on the operation being performed. Under normal operation, the pressure threshold value may be a first value and under a flush operation, the pressure threshold value may be a second value greater than the first value. A controller of the cotton harvesting work vehicle 100 may control the pump to send liquid down the tube 145 to each spindle cleaning assembly 120 when the harvesting units 114 are operating. The control may then turn off the pump when the harvesting units 114 are not operating. This allows the fluid to only be sent to the applicator pads 150 of each spindle cleaning assembly 120 when the spindles 122 may be rotating around the rotation axis 124 and as such passing by the applicator pads 150.

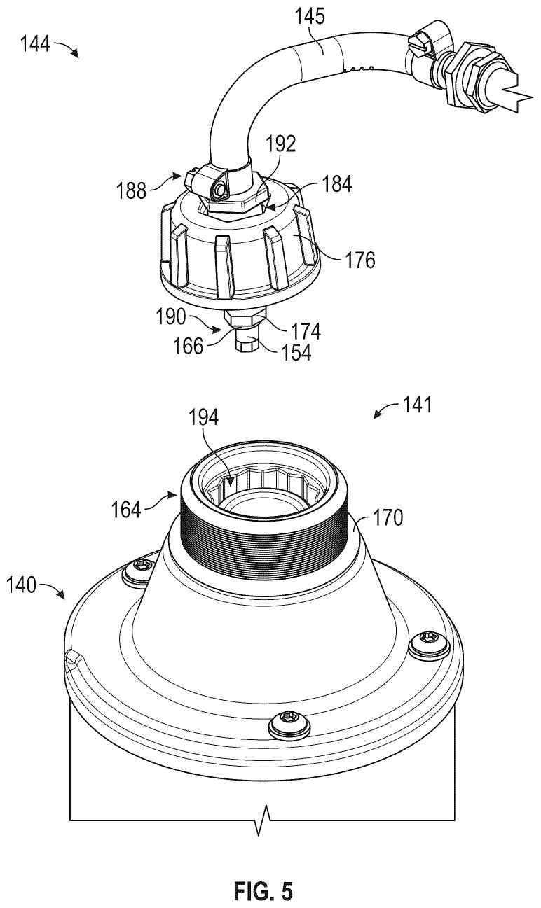

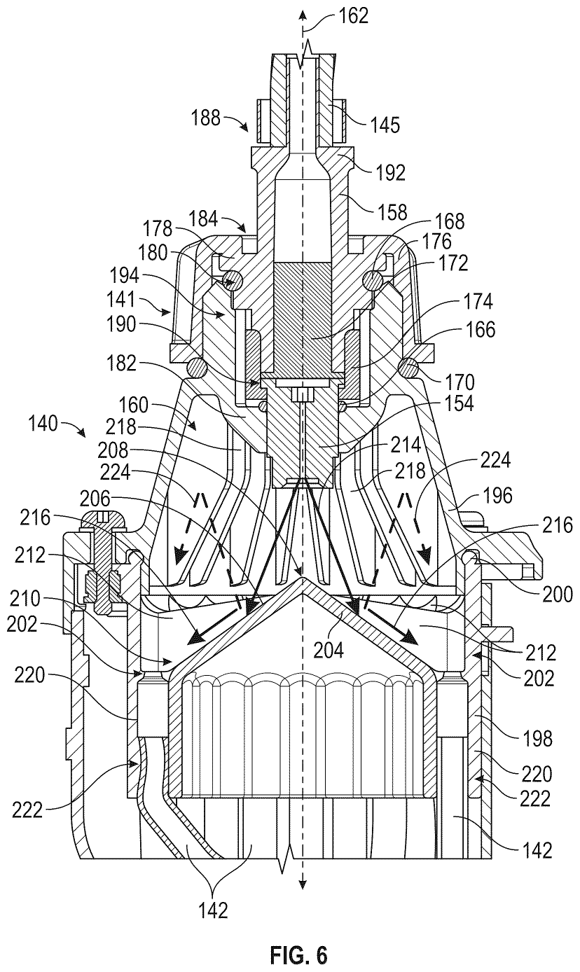

Referring to FIGS. 5 and 6, the fluid inlet 144 may include the fluid inlet housing 158, a nozzle O-ring 166, a housing O-ring 168, an outer O-ring 170, a strainer 172, a nozzle nut 174, a hand nut 176, and the fluid nozzle 154. The strainer 172 may inserted into an outlet end 190 of the fluid inlet housing 158. The nozzle 154 may insert through the nozzle nut 174. The nozzle nut 174 may be screwed onto threads on the outlet end 190 of the fluid inlet housing 158 attaching the nozzle 154 to the fluid inlet housing 158. The fluid nozzle 154 may rest against the strainer 172 when the nozzle nut 174 is tightened. The fluid inlet housing 158 may include a radial protrusion 178 with an annular channel 180 in the radial protrusion 178. The housing O-ring 168 may be positioned within the annular channel 180. The outer O-ring 170 is positioned around the receiving end 141 and the nozzle 154 is inserted through the nozzle O-ring 166. The

The fluid inlet 144 may insert into an opening in the receiving end 141 of the fluid distributor 140. The fluid distributor 140 may include an upper radial protrusion 182 that extends toward the longitudinal axis 162. The fluid inlet 144 may insert into the receiving end 141 and the hand nut 176 may screw onto threads 164 on the receiving end 141 to tighten and hold the fluid inlet 144 against the fluid distributor 140. For example, the radial protrusion 178 may be pressed between the hand nut 176 and the fluid distributor 140 to hold the fluid inlet 144 in position. When the fluid inlet 144 is inserted into the receiving end 141 of the fluid distributor 140, the fluid nozzle 154 may extend past the upper radial protrusion 182. There may be a tight tolerance between the upper radial protrusion 182 and the fluid nozzle 154. The nozzle 154 may contact the upper radial protrusion 182 with the upper radial protrusion 182 directing the nozzle 154 to point along the longitudinal axis 162. Stated another way, the upper radial protrusion 182 may align the nozzle 154 with the longitudinal axis 162.

When the hand nut 176 is fully tightened, each of the O-rings 166, 168, 170 may be pressed between the fluid inlet 144 and the fluid distributor 140 to form a liquid seal between the fluid inlet 144 and the fluid distributor 140. The nozzle O-ring may surround the nozzle 154 and be compressed between the nozzle nut 174 and the upper radial protrusion 182. The outer O-ring may surround the receiving end 141 and be compressed against the hand nut 176 and an exterior surface of the fluid distributor 140. The housing O-ring 168 may be positioned around the fluid inlet housing 158 and be compressed against an internal surface of the opening in the receiving end 141. The O-rings 166, 168, 170 may provide a liquid seal allowing fluid to flow through the fluid inlet housing 158 and into the interior distribution chamber 160 of the fluid distributor 140.

The fluid distributor 140 may be formed by an upper body 196 attached to a lower body 198. The interior distribution chamber 160 may be defined by the internal surface of the fluid distributor 140. An O-ring 200 may be compressed between the upper body 196 and lower body 198 to form a liquid seal between the upper body 196 and lower body 198.

The fluid distributor 140 is configured to distribute fluid from the nozzle 154 to an array of outlet openings 202, where the distributor tubes 142 may be attached to the fluid distributor 140 such that the distributor tubes 142 are fluidically coupled to the outlet openings 202. The fluid distributor 140 includes an impingement plate 204 as part of the lower surface of the fluid distributor 140. The interior distribution chamber 160 is defined at least in part by the impingement plate 204. The fluid from the nozzle 154 is configured to spray on the impingement plate 204. The impingement plate 204 may be higher along the longitudinal axis 162 at the center than the outer edge. For example, the impingement plate 204 may include a tapered surface 206 (e.g., a tapered conical surface) with an apex 208 and base 210 centered along the longitudinal axis 162. The tapered surface 206 extending toward the nozzle 154 along the longitudinal axis 162. The outlet openings 202 in be positioned in the lower surface of the fluid distributor 140 and may be angularly spaced about the longitudinal axis 162. The outlet openings 202 may be distributed evenly around the longitudinal axis 162. The outlet openings 202 may be positioned proximate the outer edge of the impingement plate 204. As such, the fluid exiting the nozzle may contact the impingement plate 204 and flow down the impingement plate 204 to the array of outlet openings 202.

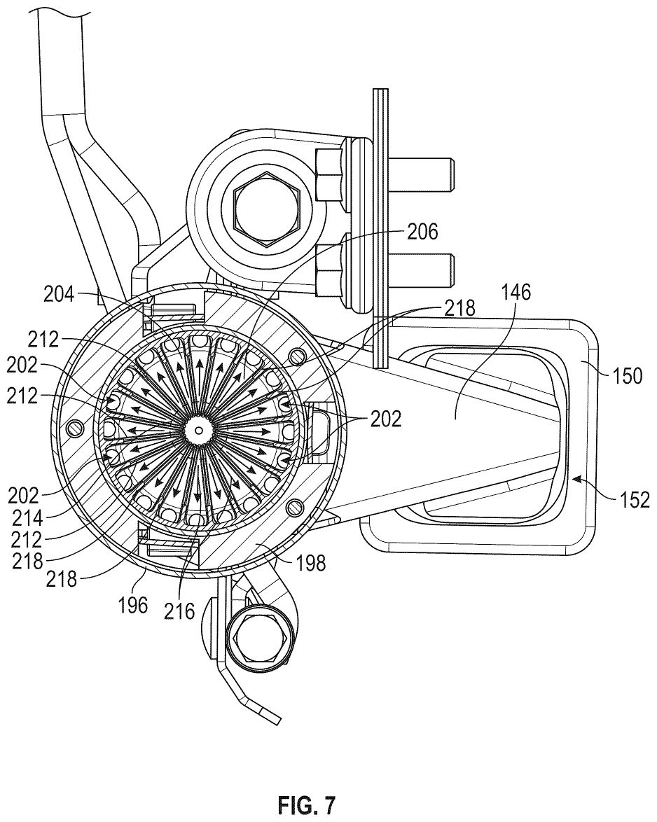

Referring to FIGS. 6 and 7, the fluid distributor 140 may include raised flow dividers 212 angularly spaced about the longitudinal axis 162 to distribute the sprayed fluid radially outward to the array of outlet openings 202. The raised flow dividers 212 may be coupled to the impingement plate 204 or they may be integrally formed with the impingement plate 204. The raised flow dividers 212 may extend along the impingement plate 204 and up the tapered surface 206. The raised flow dividers 212 may extend along the longitudinal axis 162 from the tapered surface 206 toward the apex 208 of the tapered surface 206. The raised flow dividers 212 may extend at least three quarters up the longitudinal height of the tapered surface 206. The longitudinal height being measured along the longitudinal axis 162.

The raised flow dividers 212 help to overcome surface tension of the sprayed fluid, which may act like a plug stopping the fluid from flowing smoothly to and out the outlet openings 202. Each outlet opening 202 may be positioned between two raised flow divider 212. The fluid may be sprayed in a hollow cone 214 onto the tapered surface 206 of the impingement plate 204. The nozzle 154 may be directed to spray along the longitudinal axis 162. As such, when fluid is exiting the nozzle 154, the formed hollow cone of fluid is pointed at the impingement plate along the longitudinal axis 162. The radius of the base 210 of the hollow cone 214 may be great enough for the fluid to spray onto the raised flow dividers 212 and tapered surface 206 as shown in FIG. 7. As such, the fluid from the fluid nozzle 154 may contact the tapered surface 206 around the apex 208 of the tapered surface 206.

Gravity may cause the sprayed fluid to flow down the tapered surface 206 of the impingement plate 204 to the outlet openings 202 as shown by flow arrows 216. The sprayed fluid may be caught between the raised flow dividers 212. The raised flow dividers 212 may guide the fluid to an outlet opening 202 allowing an even distribution of fluid to each outlet opening 202. The raised flow dividers 212 may function as channels that catch the sprayed fluid and guide the fluid to an outlet opening 202. For example, if the cotton harvesting work vehicle 100 is on sloped ground the raised flow dividers 212 may catch the sprayed fluid and prevent gravity from flowing more fluid to one outlet opening 202 compared to another outlet opening 202.

Referring to FIG. 6, the fluid distributor 140 may include a protrusion 220 extending along the longitudinal axis 162. The protrusion 220 may define holes 222 extending through the protrusion 220. Each hole 222 may align with an outlet opening 202. Each hole 222 may have a distributor tube 142. The fluid sprayed from the nozzle 154 exits the interior distribution chamber 160 through the outlet openings 202, and the fluid may then flow down the holes 222 and into the distributor tubes 142.

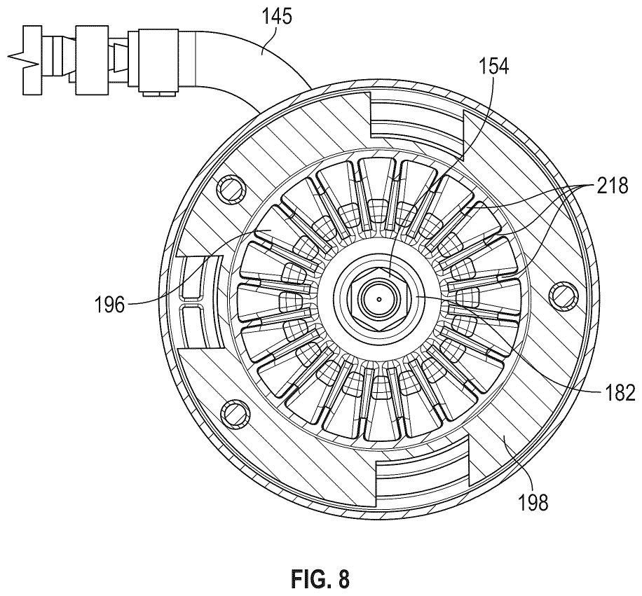

Referring to FIGS. 6-8, the fluid distributor 140 may also include upper flow dividers 218 angularly spaced about the longitudinal axis 162. The upper flow dividers 218 may run along the interior surface in the direction of the longitudinal axis 162 and may extend toward the longitudinal axis 162. The upper flow dividers 218 may be tapered towards the raised flow dividers 212. The upper flow dividers 218 may break up turbulence within the interior distribution chamber 160 allowing the fluid to flow smoothly to the impingement plate 204. For example, the upper flow dividers 218 may break up any swirling within the interior distribution chamber 160 due to the spraying of fluid from the nozzle 154.

The fluid is sprayed under pressure out of a nozzle 154 and as such, some fluid may splash off the impingement plate 204 and onto the walls of the interior distribution chamber 160. This splashed fluid may follow the flow path 224, where the fluid may splash off the impingement plate 204 onto the walls of the interior distribution chamber 160 and then flow down the walls and upper flow dividers 218. The upper flow dividers 218 may guide this splashed fluid down the walls of the interior distribution chamber 160 to reach an outlet opening 202. The upper flow dividers 218 may be aligned with the raised flow dividers 212. There may be the same number of upper flow dividers 218 as raised flow dividers 212. As such, the upper flow dividers 218 may guide the splashed fluid down the walls of the interior distribution chamber 160 to between raised flow dividers 212. This process allows even the splashed fluid or any other fluid that builds up on the walls to be segregated and guided to the outlet openings 202 providing an even distribution of the fluid to each outlet opening 202.

As discussed above, the fluid is sprayed under pressure out of the nozzle 154. During normal operation, the fluid pressure may be at a first pressure threshold. Under a flush operation, the fluid pressure may be at a second pressure threshold greater than the first pressure threshold. As such, more fluid passes through the fluid distributor 140 during a flush operation than normal operation to provide more fluid to the applicator pads 150 to clean and lubricate the spindles 122.

The flush operation may be initiated by the operator pressing a button. The pressing of the button may cause a controller of the cotton harvesting work vehicle 100 to increase the pressure at the fluid pump providing more fluid to the fluid distributor 140. In an additional/alternative aspect, the flush operation may be automated by the controller to perform a flush operation for critical harvesting moments, which reduces operator workload and enhances overall harvesting performance. For example, the controller may initiate a flush operation after a period of time. For example, perform a flush operation after 10 minutes of normal operation. The controller may also determine that the cotton harvesting work vehicle 100 has completed harvesting a row of cotton and then perform the flush operation. For example, the controller may detect that the cotton harvesting work vehicle 100 is turning at an angle greater than a threshold and initiate the flush operation. The threshold angle may be an angle great enough to turn the cotton harvesting work vehicle 100 and align with a new row of cotton for harvesting. The controller may also automatically initiate a flush operation when the cotton harvesting unit 114 is initially engaged for harvesting. In any case, the controller may automate the flush operation and receive input from a button so the controller may initiate a flush operation automatically or receive an input from an operator to initiate a flush operation.

Referring to FIGS. 5 and 6, the nozzle 154 may need removed to be replaced or cleaned due to damage to the nozzle 154, the strainer 172 being clogged, and/or the nozzle 154 being clogged. The fluid inlet 144 and fluid distributor 140 are designed to provide a tool-less removal and attachment of the nozzle 154. The hand nut 176 defines an internal geometric opening 184. The inlet end 188 of the fluid inlet housing 158 may have an external geometric feature 192. When the hand nut 176 is not attached to the receiving end 141, the hand nut 176 may be moved along the fluid inlet housing 158 to mate the internal geometric opening 184 with the external geometric feature 192. The internal geometric opening 184 and the external geometric feature 192 may have matching shape (e.g., a star, hexagon, etc.). Mating the internal geometric opening 184 with the external geometric feature 192 allows the user to rotate the hand nut 176 and have the fluid inlet housing 158 rotate with the hand nut 176. The fluid inlet 144 may be inserted into the opening in the receiving end 141 of the fluid distributor 140. The receiving end 141 may have an internal geometric feature 194 that mates with the nozzle nut 174 as the nozzle nut 174 is inserted into the receiving end 141. The internal geometric feature 194 may be a hexagon, a starred hexagon (two or more hexagons rotated relative to each other), or any other shape that can mate with the nozzle nut 174. The fluid distributor 140 is held is positioned through its attachment to the housing 138 and cotton harvesting unit 114. As such, the user may rotate the hand nut 176 which when mated with the external geometric feature 192 of the fluid inlet housing 158 causes the fluid inlet housing 158 to rotate relative to the nozzle nut 174 held in place by the nozzle nut 174 mating with the internal geometric feature 194 of the fluid distributor 140. As such, the user may rotate by hand the fluid inlet housing 158 to loosen or tighten the nozzle nut 174 holding the nozzle 154 in position allowing the user to remove the nozzle 154 to clean the nozzle 154 or strainer 172, or replace the nozzle 154 or strainer 172.

Although the present disclosure has been described with reference to example implementations, workers skilled in the art will recognize that changes may be made in form and detail without departing from the spirit and scope of the claimed subject matter. For example, although different example implementations may have been described as including features providing one or more benefits, it is contemplated that the described features may be interchanged with one another or alternatively be combined with one another in the described example implementations or in other alternative implementations. The present disclosure described with reference to the example implementations and set forth in the following claims is manifestly intended to be as broad as possible. For example, unless specifically otherwise noted, the claims reciting a single particular element also encompass a plurality of such particular elements. The terms “first,” “second,” “third,” and so on in the claims merely distinguish different elements and, unless otherwise stated, are not to be specifically associated with a particular order or particular numbering of elements in the disclosure. Although portions of the disclosure may use the phrase “at least one” or “one or more” of a particular component or element, unless otherwise specifically limited, the mere recitation of a single element or component does not preclude a plurality of such elements or components.

What is claimed is:

1. A spindle cleaning assembly for a harvesting unit of a cotton harvesting work vehicle comprising:
a fluid nozzle;
a fluid distributor carried by a housing panel of the harvesting unit and configured to receive fluid from the fluid nozzle, the fluid distributor defining an interior distribution chamber disposed about a longitudinal axis and the interior distribution chamber defined at least in part by an impingement plate at which the fluid nozzle is configured to spray a fluid, the impingement plate having raised flow dividers angularly spaced about the longitudinal axis to distribute the fluid radially outward to an array of outlet openings;
distributor tubes attached to the fluid distributor, one at each of the outlet openings; and
a column of applicator pads carried by the housing panel to be spaced apart along the housing panel and receive fluid from the fluid distributor through the distributor tubes.

2. The spindle cleaning assembly of claim 1, wherein the impingement plate is higher at its center than at an outer edge.

3. The spindle cleaning assembly of claim 1, wherein the impingement plate includes a tapered conical surface, and wherein the raised flow dividers extend along the longitudinal axis from the tapered conical surface toward an apex of the tapered conical surface.

4. The spindle cleaning assembly of claim 1, the fluid distributor further comprising upper flow dividers angularly spaced about the longitudinal axis.

5. The spindle cleaning assembly of claim 4, wherein the upper flow dividers are tapered along the longitudinal axis.

6. The spindle cleaning assembly of claim 4, wherein each upper flow divider is aligned with a raised flow divider.

7. The spindle cleaning assembly of claim 1, wherein each outlet opening is positioned between two raised flow dividers.

8. The spindle cleaning assembly of claim 1, wherein the outlet openings are distributed evenly around the longitudinal axis.

9. The spindle cleaning assembly of claim 1, wherein the fluid nozzle is configured to distribute fluid into the interior distribution chamber in a hollow cone, and wherein the fluid nozzle is positioned for the hollow cone to point at the impingement plate along the longitudinal axis.

10. The spindle cleaning assembly of claim 1, wherein the impingement plate includes a tapered conical surface, wherein the fluid nozzle is configured to distribute fluid into the interior distribution chamber in a hollow cone, and wherein the fluid from the fluid nozzle contacts the tapered conical surface around an apex of the tapered conical surface.

11. A harvesting unit of a cotton harvesting work vehicle, the harvesting unit comprising:
a spindle drum comprising an array of spindle holding bars configured to rotate about a rotation axis of the spindle drum, wherein each spindle holding bar comprises a column of spindles;
a spindle cleaning assembly for cleaning and lubricating each spindle of the column of spindles, wherein during rotation of the spindle drum each spindle holding bar passes through the spindle cleaning assembly, the spindle cleaning assembly comprising:
a fluid nozzle;
a fluid distributor carried by a housing panel of the harvesting unit and configured to receive fluid from the fluid nozzle, the fluid distributor defining an interior distribution chamber disposed about a longitudinal axis and the interior distribution chamber defined at least in part by an impingement plate at which the fluid nozzle is configured to spray a fluid, the impingement plate having raised flow dividers angularly spaced about the longitudinal axis to distribute the fluid radially outward to an array of outlet openings;
distributor tubes attached to the fluid distributor, one at each of the outlet openings; and
a column of applicator pads carried by the housing panel to be spaced apart along a longitudinal axis and receive fluid from the fluid distributor through the distributor tubes,
wherein the column of spindles of a spindle holding bar contacts the column of applicator pads as the spindle holding bar passes through the spindle cleaning assembly.

12. The harvesting unit of claim 11, wherein the impingement plate is higher at its center than at an outer edge.

13. The harvesting unit of claim 11, wherein the impingement plate includes a tapered conical surface, and wherein the raised flow dividers extend along the longitudinal axis from the tapered conical surface toward an apex of the tapered conical surface.

14. The harvesting unit of claim 11, the fluid distributor further comprising upper flow dividers angularly spaced about the longitudinal axis.

15. The harvesting unit of claim 14, wherein the upper flow dividers are tapered along the longitudinal axis.

16. The harvesting unit of claim 14, wherein each upper flow divider is aligned with a raised flow divider.

17. The harvesting unit of claim 11, wherein each outlet opening is positioned between two raised flow dividers.

18. The harvesting unit of claim 11, wherein the outlet openings are distributed evenly around the longitudinal axis.

19. The harvesting unit of claim 11, wherein the fluid nozzle is configured to distribute fluid into the interior distribution chamber in a hollow cone, and wherein the fluid nozzle is positioned for the hollow cone to point at the impingement plate along the longitudinal axis.

20. The harvesting unit of claim 11, wherein the impingement plate includes a tapered conical surface, wherein the fluid nozzle is configured to distribute fluid into the interior distribution chamber in a hollow cone, and wherein the fluid from the fluid nozzle contacts the tapered conical surface around an apex of the tapered conical surface.
